(19) United States
(12) Patent Application Publication
(10) Pub. No.: US 2024/0295578 A1
(43) Pub. Date: Sep. 5, 2024

(54) DEVICE FOR DETECTING THE DIRECTION OF ROTATION OF A ROTOR, ASSOCIATED CONTROL AND DRIVE SYSTEMS, AND ASSOCIATED METHOD

(71) Applicant: SKF Magnetic Mechatronics, Saint-Marcel (FR)

(72) Inventors: Sylvain PALMERI, Angerville la campagne (FR); Lakdar SADI-HADDAD, Nogent sur Marne (FR)

(21) Appl. No.: 18/585,189

(22) Filed: Feb. 23, 2024

(30) Foreign Application Priority Data
Mar. 2, 2023 (FR) 2301931

(51) Int. Cl. G01P 13/04; F16C 32/04

(52) U.S. Cl. CPC G01P 13/045; F16C 32/0474

(57) ABSTRACT

A device (17) for detecting the direction of rotation of a rotor for a magnetic bearing includes comparing means (100), first determining means (105), and second determining means (107). The comparing means (100) compares the speed of rotation of the rotor with a predefined speed threshold (Se). The first determining means (105) determines the speed of rotation gradient of the rotor. The second determining means (107) determines the direction of rotation of the rotor from the result of the comparison of the speed of rotation of the rotor with the predefined speed threshold (Se) and the value of the determined parameter representative of the kinetics of the rotor.

### CROSS-REFERENCE TO RELATED APPLICATION

This application claims priority to French Application No. 2301931, filed Mar. 2, 2023, the entirety of which is hereby incorporated by reference.

### FIELD

The present disclosure relates to the control of magnetic bearings.

The present disclosure more particularly relates to a device for detecting the direction of rotation of a rotor of a magnetic bearing, to a system for controlling a magnetic bearing comprising such a device, to a drive system having such a system and a magnetic bearing, and to a method for detecting a change in the direction of rotation of the rotor.

### BACKGROUND

Conventionally, magnetic bearings are implemented in systems having a rotor operating at a high rotational speed.

A magnetic bearing supports the rotor by magnetic levitation in a stator of the system.

The magnetic bearings are controlled by a control system generally comprising a synchronous filter implementing algorithms for controlling the magnetic bearing.

The synchronous filter comprises a modulation module which changes the reference system from a stator reference system to a rotor reference system, an algorithm for controlling the magnetic bearing which performs operations in the rotor reference system in order to simplify said operations, and a demodulation module which changes the reference system from the rotor reference system to the stator reference system.

The operations for changing the reference system implement trigonometric functions that depend on the direction of rotation of the rotor.

When the control system is started up, the direction of rotation of the rotor is defined and input in the modulation and demodulation modules manually by an operator.

If the direction of rotation that was input is not representative of the direction of rotation of the rotor, the modulation module supplies a zero value after filtering.

The operator can make an error regarding the direction of rotation that is liable to adversely affect the system in which the bearing is implemented.

Moreover, when it is necessary to modify the direction of rotation, an operator must intervene to manually change the direction of rotation of the rotor.

It is therefore proposed to overcome all or some of these drawbacks.

### SUMMARY

In light of the above, the present disclosure proposes a method for detecting a change in the direction of rotation of a rotor of a magnetic bearing, comprising:
determining the speed of rotation gradient of the rotor,
comparing the speed of rotation of the rotor with a predefined speed threshold, and
detecting a change in the direction of rotation of the rotor from the result of the comparison of the speed of rotation of the rotor with the predefined speed threshold and the determined speed of rotation gradient of the rotor.

The change in the direction of rotation of the rotor is detected from the speed of rotation of the rotor and from the speed of rotation gradient of the rotor in order to adapt the algorithms for controlling the magnetic bearing autonomously and automatically without manual intervention by an operator.

Advantageously, when the rotor revolves in a first direction of rotation, the method comprises:
detecting a first reversal of the direction of rotation of the rotor in a second direction of rotation that is counter to the first direction of rotation, when the absolute value of the speed of rotation of the rotor is less than the speed threshold and when the speed gradient is negative, and
detecting a second reversal of the direction of rotation of the rotor in the first direction of rotation following the first reversal when the speed gradient is greater than or equal to zero, and when the absolute value of the speed of rotation of the rotor is less than the speed threshold.

What is also proposed is a device for detecting a change in the direction of rotation of a rotor for a magnetic bearing, comprising:
comparing means configured to compare the speed of rotation of the rotor with a predefined speed threshold,
first determining means configured to determine the speed of rotation gradient of the rotor, and
second determining means configured to detect the change in the direction of rotation of the rotor from the result of the comparison of the speed of rotation of the rotor with the predefined speed threshold and the determined speed of rotation gradient of the rotor.

Preferably, the second determining means are configured to:
detect a first reversal of the direction of rotation of the rotor in a second direction of rotation that is counter to the first direction of rotation, when the absolute value of the speed of rotation of the rotor is less than the speed threshold and when the speed gradient is negative, and
detect a second reversal of the direction of rotation of the rotor in the first direction of rotation following the first reversal when the speed gradient is greater than or equal to zero, and when the absolute value of the speed of rotation of the rotor is less than the speed threshold.

What is also proposed is a control system for a magnetic bearing comprising a device as defined above, and a synchronous filter including at least one algorithm for managing the magnetic bearing, the algorithm comprising a variable gain managed by said device depending on the direction of rotation of the rotor.

The synchronous filter preferably comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

Advantageously, the synchronous filter also comprises a control module connected on the one hand to the modulation module and on the other hand to the demodulation module, the control module implementing an algorithm for correcting the imbalance of the rotor.

What is also proposed is a drive system comprising a magnetic bearing having a rotor and a stator having coils distributed evenly in the stator forming at least one servocontrol spindle, a power converter supplying power to the servocontrol spindle, and a control system as defined above managing the power converter.

### BRIEF DESCRIPTION OF THE DRAWINGS

Further aims, features and advantages of the present disclosure will become apparent from reading the following description, which is given purely by way of nonlimiting example and with reference to the appended drawings, in which:

FIG. 1 illustrates an example of a drive system according to the present disclosure;

FIG. 2 schematically illustrates an exemplary embodiment of a control system for a magnetic bearing according to the present disclosure;

FIG. 3 schematically illustrates one embodiment of a modulation module according to the present disclosure;

FIG. 4 schematically illustrates an exemplary embodiment of a control module according to the present disclosure;

FIG. 5 schematically illustrates an exemplary embodiment of the detection device according to the present disclosure; and

FIG. 6 illustrates an implementation example for the exemplary embodiment of the detection device according to the present disclosure.

### DETAILED DESCRIPTION

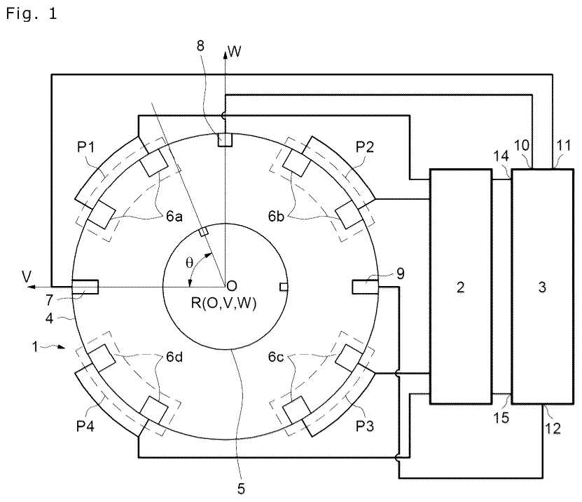

Reference is made to FIG. 1, which illustrates a drive system comprising a magnetic bearing 1, a power converter 2 and a control system 3.

As is known per se, the magnetic bearing 1 comprises a stator 4 and a rotor 5 positioned in the stator 4, and a direct orthogonal reference system R(O, V, W) having two aces V, W and an origin O centred on the axis of rotation of the rotor 5.

The stator 4 comprises coils 6 distributed evenly in the circumferential direction of the inner side of the stator 4, two diametrically opposite coils being connected to one another so as to be supplied with power at the same time by the power converter 2.

Two diametrically opposite stator coils define a servocontrol spindle of the magnetic bearing and make it possible to manage this spindle.

The stator 4 comprises for example four coils 6a, 6b, 6c, 6d forming four pairs of poles P1, P2, P3, P4 connected to the power converter 2.

The stator 4 also comprises two position sensors 7, 8 for the rotor 5 that measure the position of the rotor 5.

A first position sensor 7 is disposed on a first axis V of the reference system R(O, V, W) and a second position sensor 8 is disposed on the second axis W of the reference system R(O, V, W).

The stator 4 also comprises a speed sensor 9 that measures the speed of rotation of the rotor 5.

The measurements generated by the position sensors 7, 8 are sent to the inputs 10, 11 of the control system 3 and the measurements generated by the speed sensor are sent to a third input 12 of the control system 3.

The control system 3 also comprises two outputs 14, 15 connected to the power converter 2.

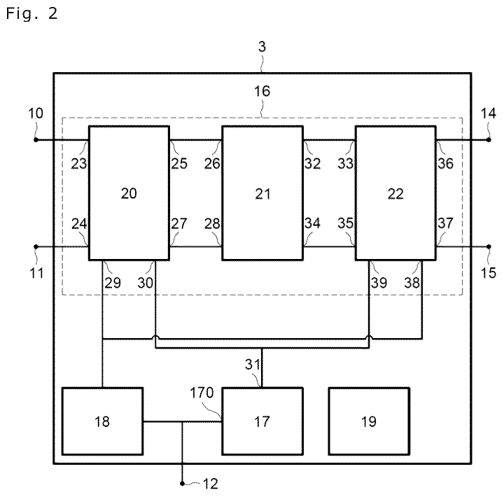

FIG. 2 schematically illustrates an exemplary embodiment of the control system 3.

The control system 3 comprises a synchronous filter 16, a device 17 for detecting a change in the direction of rotation of the rotor 5, and means 18 for determining the angular position of the rotor 5 from the measurements supplied by the speed sensor 9.

The control system 3 also comprises a processing unit 19 implementing the synchronous filter 16, the detection device 17, and the means 18 for determining the angular position connected to the third input 12.

The angular position determining means 18 determine, in a known manner, the angular position of the rotor 5 from the data generated by the speed sensor 9 by estimating the duration needed for the rotor 5 to perform one revolution over a first period of rotation of the rotor 5, then carries out a linear interpolation over the estimated duration to estimate the position of the rotor 5 over a second period following the first period of rotation.

The synchronous filter 16 comprises a modulation module 20, a control module 21 and a demodulation module 22.

The modulation module 20 comprises a first input 23 connected to a first input 10 of the control system 3, a second input 24 connected to the second input 11 of the control system 3, a first output 25 connected to a first input 26 of the control module 21, and a second output 27 connected to a second input 28 of the control module 2.

The modulation module 20 also comprises a third input 29 connected to the angular position determining means 18, and a control input 30 connected to an output 31 of the detection device 17.

The detection device 17 comprises an input 170 connected to the third input 12 of the control system 3.

The control module 21 comprises a first output 32 connected to a first input 33 of the demodulation module 22, and a second output 34 connected to a second input 35 of the demodulation module 22.

The demodulation module 22 also comprises a first output 36 connected to the first output 14 of the control module 3, and a second output 37 connected to a second output 15 of the control module 3.

The demodulation module 22 also comprises a third input 38 connected to the angular position determining means 18, and a control input 39 connected to an output 31 of the detection device 17.

As is known, the modulation module 20 filters the sinusoidal signals supplied by the position sensors 7, 8 such that the first output 25 supplies a first continuous value indicative of the amplitude of the sinusoidal signal supplied by the first position sensor 7, and such that the second output 27 supplies a second continuous value indicative of the amplitude of the sinusoidal signal supplied by the second position sensor 8.

The modulation module 20 implements a low-frequency filtering algorithm allowing frequencies to pass that are equal to the frequency of rotation of the rotor 5 to within a threshold so as to also make it possible to change the basis of the reference system R(O, V, W) to a direct orthogonal reference system R1 of the rotor 5 of which the origin is a point on the axis of rotation of the rotor 5.

The threshold is for example equal to 10 Hz.

The control module 21 implements an algorithm for correcting the imbalance determined by the modulation module 20 and the demodulation module 22 changes the reference system R1 linked to the rotor 5 to the reference system R linked to the stator 4.

As the modulation module 20 and demodulation module 22 have similar structures, only one exemplary embodiment of the modulation module 20 and one exemplary embodiment of the processing module 21 are presented below.

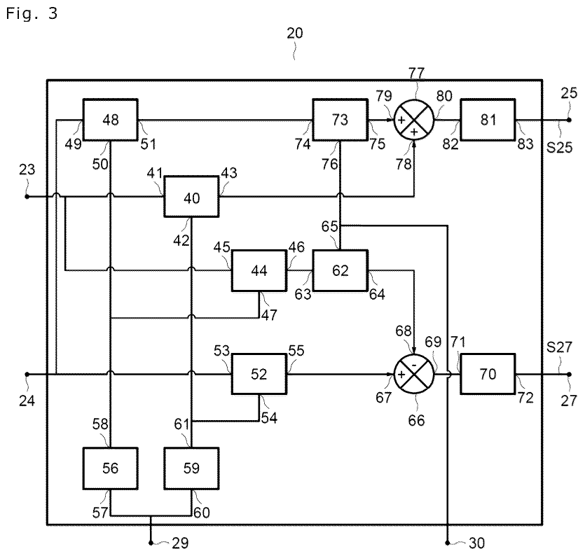

FIG. 3 schematically illustrates an exemplary embodiment of the modulation module 20.

The modulation module 20 comprises four multipliers 40, 44, 52, 48 each comprising a first input 41, 45, 49, 53, a second input 42, 47, 50, 52, and an output 43, 46, 51,55.

The modulation module 20 comprises a sine operator 56 comprising an input 57 connected to the third input 29 of the modulation module 20 and an output 58 connected to the second inputs 47, 50 of a second and a third multiplier 44, 48.

The modulation module 20 also comprises a cosine operator 59 comprising an input 60 connected to the third input 29 of the modulation module 20 and an output 61 connected to the second inputs 42, 54 of a first and a fourth multiplier 44, 52.

The first inputs 41, 54 of the first and the second multiplier 40, 44 are connected to the first input 23 of the modulation module 20, and the first inputs 49, 53 of the third and the fourth multipliers 48, 52 are connected to the second input 24 of the modulation module 20.

The modulation module 20 also comprises a first variable gain 62 comprising an input 63 connected to the output 46 of the second multiplier 44, an output 64, and a management input 65 connected to the control input 30 of the modulation module 20.

The modulation module 20 comprises a first adder 66 comprising an addition input 67 connected to the output 55 of the fourth adder 52, a subtraction input 68 connected to the output 64 of the first gain 62, and an output 69 connected to an input 71 of a saturator 70 of the module 20.

The saturator 70 also comprises an output 72 connected to the second output 27 of the module 20.

The modulation module 20 also comprises a second variable gain 73 comprising an input 74 connected to the output 51 of the third multiplier 48, an output 75, and a management input 76 connected to the control input 30 of the modulation module 20.

The module comprises a second adder 77 comprising a first addition input 78 connected to the output 43 of the first adder 40, a second addition input 79 connected to the output 75 of the second gain 73, and an output 80 connected to an input 82 of a second saturator 81 of the module 20.

The second saturator 81 also comprises an output 83 connected to the first output 25 of the module 20.

The saturators 70, 81 make it possible to avoid the reversals of variables relating to the fixed-point algorithms.

The first and second gains 62, 73 are managed such that they multiply the value received at their input 63, 74 by a multiplying coefficient which takes the numerical value 1 or −1 depending on the direction of rotation of the rotor 5.

If the direction of rotation of the rotor 5 is oriented from the axis V to the axis W in the reference system R (reverse direction), the multiplying coefficient is for example equal to 1, and if the direction of rotation of the rotor 5 is oriented from the axis W to the axis V in the reference system R (forward direction), the multiplying coefficient is equal to −1.

The value of the multiplying coefficient is determined by the detection device 17, as described below.

It is assumed that the first position sensor 7 supplies a sinusoidal signal Vcos and that the second position sensor 8 supplies a sinusoidal signal Vsin such that:

$$Vcos = A cos ( θ ) \qquad ( 1 )$$

$$Vsin = A sin ( θ ) \qquad ( 2 )$$

where A is the amplitude of the signals and θ is the angular position of the rotor 5.

When the rotor 5 revolves in the forward direction, the coefficient of the gains 62, 73 is equal to 1. A signal S25 at the first output 25 and a signal S27 at the second output 27 are equal to:

$$S 25 = Asin ( θ ) sin ( θ ) + Acos ( θ ) cos ( θ ) = A \qquad ( 3 )$$

$$S 27 = Asin ( θ ) cos ( θ ) - Acos ( θ ) sin ( θ ) = 0 \qquad ( 4 )$$

When the rotor 5 revolves in the reverse direction, the coefficient of the gains 62, 73 is equal to −1. The signal S25 at the first output 25 and the signal S27 at the second output 27 are equal to:

$$S 25 = - Acos ( θ ) sin ( θ ) + Asin ( θ ) cos ( θ ) = 0 \qquad ( 3 )$$

$$S 27 = Acos ( θ ) cos ( θ ) + Asin ( θ ) sin ( θ ) = A \qquad ( 4 )$$

The first and second non-zero continuous values supplied at the outputs 25, 27 are representative of the spacing between the axis of rotation of the rotor 5 and the centre of gravity of the rotor 5, and make it possible to quantify the imbalance of the rotor 5.

The module 20 makes it possible to filter the signals generated by the position sensors independently of the direction of rotation of the rotor 5 by selecting the gain of the gains 73, 62 to be equal to the multiplying coefficient, the selection being performed by the detection device 17.

The gain of the variable gains 73, 62 is representative of the direction of rotation of the rotor 5.

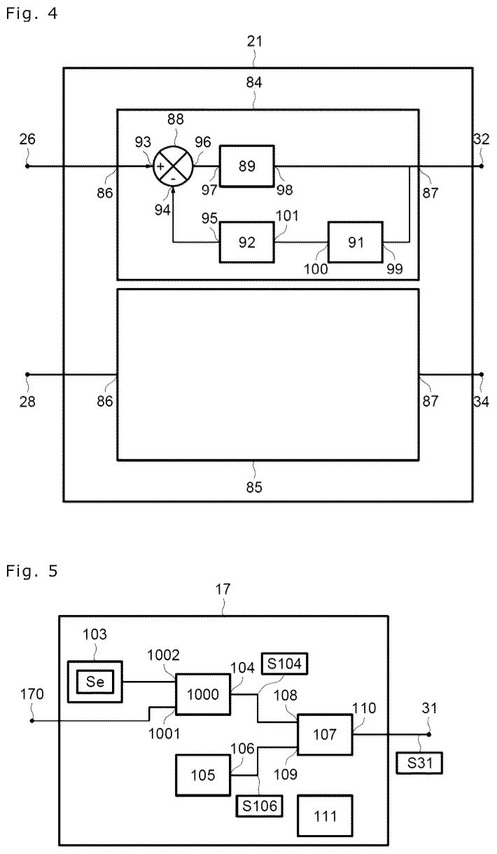

FIG. 4 schematically illustrates an exemplary embodiment of the control module 21 that makes it possible to compensate the imbalance of the rotor 5 determined by the modulation module 20.

The modulation module 20 has two identical regulating loops 84, 85 each having an input 86 and an output 87.

The input 86 and the output 87 of a first regulating loop 84 are connected to the first input 26 and to the first output 32, respectively, of the control module 21.

The input 86 and the output 87 of the second regulating loop 85 are connected to the second input 28 and to the second output 34, respectively, of the control module 21.

Since the regulating loops 84, 85 are identical, only the first loop 84 is described in detail.

The first loop 84 comprises an adder 88, an integrator 89, a gain 91 and a saturator 92.

The adder 88 comprises an addition input 93 connected to the input 86, a subtraction input 94 connected to an output 95 of the saturator 92, and an output 96 connected to an input 97 of the integrator 89.

An output 98 of the integrator is connected to the output 87 and to an input 99 of the gain.

An output 100 of the gain 91 is connected to an input 101 of the saturator 92.

FIG. 5 discloses an exemplary embodiment of the detection device 17.

The device 17 comprises comparing means 1000 comprising a first input 1001 connected to the input 170 of the device 17, a second input 1002 connected to a memory 103, and an output 104.

The memory 103 may be disposed in the device 17 as shown or disposed outside the device 17.

The device 17 also comprises first determining means 105 having an output 106, and second determining means 107 having a first input 108 connected to the output 104 of the comparing means 1000, a second input 109 connected to the output 106 of the first determining means 105, and an output 110 connected to the output 31 of the detection device 17.

The device 17 also comprises a second processing unit 111 implementing comparing means 1000, the memory 103, and the first and second determining means 105, 107.

The memory 103 contains a predefined speed threshold Se representative of the minimum speed of rotation of the rotor 5 measured by the speed sensor 9, the sensor 9 measuring for example a minimum frequency of 10 Hz, that is 600 revolutions per minute.

It is assumed below that the speed measured by the speed sensor 9 is the absolute value of the speed such that the measured speed is positive or zero.

The first determining means 105 determine the speed of rotation gradient of the rotor 5.

The speed gradient is for example sent to the first determining means 105 by a computer (not shown) for controlling the drive system.

The speed gradient may for example be determined from the calculation of the derivative of the speed of rotation of the rotor.

In a variant, the speed gradient is provided by a controller for controlling rotor rotating means, the rotor rotating means comprising for example an electric motor.

The comparing means 100 compare the absolute value of the speed of rotation (2 of the rotor with the speed threshold Se.

At present, an implementation example for the exemplary embodiment of the detection device 17 is illustrated in FIG. 5.

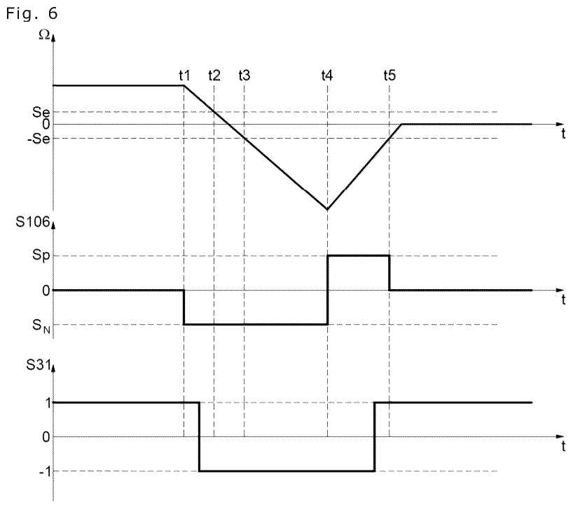

FIG. 6 illustrates an example of the change over time of the speed of rotation (2 of the rotor 5, a signal S106 supplied at the output 106 of the first determining means 105, and a signal S31 supplied at the output 31 of the detection device 17 representative of the direction of rotation of the rotor 5.

It is assumed that, before the instant t1, the rotor 5 revolves in the reverse direction at a speed of rotation having an absolute value greater than the threshold Sc.

The speed gradient determined by the first determining means 105 is zero. The signal S106 is zero, and the comparing means 1000 supply a signal S104 at the output 104 representative of the comparison, for example the signal S104 is equal to “1” when the absolute value of the speed of rotation is greater than the threshold Se, and “0” otherwise. In the present case, the signal S104 is equal to “1”.

As the signal S104 is equal to “1” and the signal S106 is zero, the second determining means 107 supply a signal representative of the value of the multiplying coefficient of the gains 62, 73 equal to “1” such that the signal S31 is equal to “1” such that the multiplying coefficient of the gains 62, 73 is equal to “1”.

At the instant t1, the speed of rotation of the rotor 5 decreases. The speed gradient determined by the first determining means 105 is negative. The signal S106 is negative and takes for example a value of SN.

As the absolute value of the speed of rotation Ω is greater than the threshold Se between the instants t1 and t2, the signal S31 remains at “1”.

The second determining means 107 supply a signal representative of the value of the multiplying coefficient of the gains 62, 73 that is equal to “1” such that the signal S31 is equal to “1”.

The multiplying coefficient of the gains 62, 73 is equal to “1”.

At the instant t2, as the absolute value of the speed of rotation Ω of the rotor is less than the threshold Se, the comparing means 1000 supply a signal S104 equal to “−1”. Moreover, as the speed gradient is negative, the signal S106 is equal to a value SN indicative of a negative gradient.

The second determining means 107 detect a reversal of the direction of rotation of the rotor 5 from the reverse direction to the forward direction counter to the reverse direction, and supply a signal representative of the value of the multiplying coefficient of the gains 62, 73 equal to “−1” such that the signal S31 is equal to “−1”. The multiplying coefficient of the gains 62, 73 is equal to “−1”.

Between the instants t2 and t3, the speed of rotation Ω continues to decrease and becomes negative since the rotor 5 revolves in the reverse direction. The absolute value of the speed of rotation Ω remains less than the threshold Se.

The signal S31 remains at “−1”.

Between the instants t3 and t4, the negative speed of rotation Ω continues to decrease.

The absolute value of the speed of rotation Ω is greater than the threshold Se and the gradient remains negative.

The signal S31 remains at “−1”.

At the instant t4, the speed of rotation Ω is negative and increases such that the speed gradient becomes positive.

The first determining means 105 supply the signal S106 equal to a value Sp indicative of a positive or zero gradient.

The absolute value of the speed of rotation is greater than the threshold Se. The signal S31 remains at “−1”.

Between the instants t4 and t5, the negative speed of rotation 2 continues to increase.

The absolute value of the speed of rotation 22 is greater than the threshold Se and the gradient remains positive.

The signal S31 remains at “−1”.

At the instant t5, the absolute value of the speed of rotation 22 is less than the threshold Se, the comparing means 1000 supply a signal S104 equal to “−1”. Moreover, as the speed gradient is positive or zero, the signal S106 is equal to the value Sp indicative of a positive or zero gradient.

The second determining means 107 detect a reversal of the direction of rotation of the rotor 5 from the forward direction to the reverse direction, and supply a signal representative of the value of the multiplying coefficient of the gains 62, 73 equal to “1” such that the signal S31 is equal to “1”.

The multiplying coefficient of the gains 62, 73 is equal to “1”.

What is claimed is:

1. A method for detecting a change in the direction of rotation of a rotor of a magnetic bearing, the method comprising:
determining the speed of rotation gradient of the rotor,
comparing the speed of rotation of the rotor with a predefined speed threshold, and
detecting the change in the direction of rotation of the rotor from the result of the comparison of the speed of rotation of the rotor with the predefined speed threshold and the determined speed of rotation gradient of the rotor.

2. The method according to claim 1, wherein, when the rotor revolves in a first direction of rotation, the method comprises:
detecting a first reversal of the direction of rotation of the rotor in a second direction of rotation that is counter to the first direction of rotation, when the absolute value of the speed of rotation of the rotor is less than the speed threshold and when the speed gradient is negative, and
detecting a second reversal of the direction of rotation of the rotor following the first reversal, when the speed gradient is greater than or equal to zero, and when the absolute value of the speed of rotation of the rotor is less than the speed threshold.

3. A device for detecting a change in the direction of rotation of a rotor for a magnetic bearing, the device comprising:
comparing means configured to compare the speed of rotation of the rotor with a predefined speed threshold,
first determining means configured to determine the speed of rotation gradient of the rotor, and
second determining means configured to detect the change in the direction of rotation of the rotor from the result of the comparison of the speed of rotation of the rotor with the predefined speed threshold and the determined speed of rotation gradient of the rotor.

4. The device according to claim 3, wherein the second determining means are configured to:
detect a first reversal of the direction of rotation of the rotor in a second direction of rotation that is counter to the first direction of rotation, when the absolute value of the speed of rotation of the rotor is less than the speed threshold and when the speed gradient is negative, and
detect a second reversal of the direction of rotation of the rotor following the first reversal when the speed gradient is greater than or equal to zero, and when the absolute value of the speed of rotation of the rotor is less than the speed threshold.

5. A control system for a magnetic bearing comprising a device according to claim 3, and a synchronous filter including at least one algorithm for managing the magnetic bearing, the algorithm comprising a variable gain managed by said device depending on the direction of rotation of the rotor.

6. The control system according to claim 5, wherein the synchronous filter comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

7. The control system according to claim 6, wherein the synchronous filter also comprises a control module connected on the one hand to the modulation module and on the other hand to the demodulation module, the control module implementing an algorithm for correcting the imbalance of the rotor.

8. A drive system comprising a magnetic bearing having a rotor and a stator having coils distributed evenly in the stator forming at least one servocontrol spindle, a power converter supplying power to the servocontrol spindle, and a control system according to claim 5 managing the power converter.

9. A control system for a magnetic bearing comprising a device according to claim 4, and a synchronous filter including at least one algorithm for managing the magnetic bearing, the algorithm comprising a variable gain managed by said device depending on the direction of rotation of the rotor.

10. The control system according to claim 9, wherein the synchronous filter comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

11. The control system according to claim 10, wherein the synchronous filter also comprises a control module connected on the one hand to the modulation module and on the other hand to the demodulation module, the control module implementing an algorithm for correcting the imbalance of the rotor.

12. A drive system comprising a magnetic bearing having a rotor and a stator having coils distributed evenly in the stator forming at least one servocontrol spindle, a power converter supplying power to the servocontrol spindle, and a control system according to claim 11 managing the power converter.
